(19) United States
(12) Patent Application Publication
(10) Pub. No.: US 2022/0286291 A1
(43) Pub. Date: Sep. 8, 2022

(54) SECURE ENVIRONMENT FOR CRYPTOGRAPHIC KEY GENERATION

(71) Applicant: COMMONWEALTH SCIENTIFIC AND INDUSTRIAL RESEARCH ORGANISATION, Australian Capital Territory (AU)

(72) Inventors: Adnene GUABTNI, Australian Capital Territory (AU); Hugo O'CONNOR, Australian Capital Territory (AU); Ingo WEBER, Australian Capital Territory (AU)

(73) Assignee: COMMONWEALTH SCIENTIFIC AND INDUSTRIAL RESEARCH ORGANISATION, Australian Capital Territory (AU)

(21) Appl. No.: 17/637,749

(22) PCT Filed: Aug. 24, 2020
(86) PCT No.: PCT/AU2020/050888

§ 371 Date: Feb. 23, 2022

(30) Foreign Application Priority Data
Aug. 23, 2019 (AU) 2019903083

(51) Int. Cl. H04L 9/32; H04L 9/08; H04L 9/00

(52) U.S. Cl. CPC H04L 9/3236; H04L 9/0819; H04L 9/006; H04L 9/0861

(57) ABSTRACT

A device (102) for generating and storing a cryptographic key pair is disclosed. The device comprises a non-persistent memory unit (116) and a processor (114). The processor (114) is configured to receive a plurality of seeds from a respective plurality of users and combine the seeds to define a composite seed. The processor (114) is further configured to generate the key pair, comprising a public key and a private key (104), using the composite seed and a deterministic key generation method, and to record the private key (104) in the non-persistent memory unit (116).

### CROSS-REFERENCE TO RELATED APPLICATIONS

The present application claims priority from Australian Provisional Patent Application No 2019903083 filed on 23 Aug. 2019, the contents of which are incorporated herein by reference in their entirety.

### TECHNICAL FIELD

The disclosure devices and methods for generating cryptographic keys.

### BACKGROUND

A variety of systems rely on cryptographic protocols to secure access to critical data or functions. The protocols typically make use of a cryptographic key pair which can be used to prevent unauthorised access to the critical data or functions. The key pairs comprise a public key and a private key which are mathematically related. The public key can be freely distributed while the related private key is kept secret. A sender is able to encrypt data using a public key associated with a receiver which can then decrypt the data using the related private key.

A similar process can be used to verify the authenticity of a digital object. This process involves a user signing the digital object using a private key of the user. The signed object can then be verified by any other party by using the public key associated with the user's private key. Assuming the user has maintained the secrecy of the private key, the verified digital signature authenticates the source of the object as well as its integrity. The authenticity of the source is guaranteed by the fact that it is only possible to create the signature using the private key associated with the user's public key. Therefore, verification guarantees that the entity creating the signature had access to the private key (which is assumed to have been kept secret).

The integrity of the digital object is guaranteed by the fact that alteration of the object after creation of the digital signature would not allow for successful verification.

These cryptographic protocols are used to execute smart contracts, initiate payments and to manage digital assets such as cryptographic currencies.

In such systems, the public keys in cryptographic key pairs are freely distributed, while the private keys remain unknown to the systems and are assumed to be managed securely by the users themselves.

### SUMMARY

According to a first aspect, there is provided a device for generating and storing a cryptographic key pair, the device comprising:

a non-persistent memory unit; and
a processor configured to:
receive a plurality of seeds from a respective plurality of users;
combine the seeds to define a composite seed;
generate the key pair using the composite seed and a deterministic key generation method, the key pair comprising a public key and a private key; and
record the private key in the non-persistent memory unit.

It is an advantage of this device that a cryptographic key pair can be generated from a plurality of seeds from a plurality of users. By using a plurality of seeds, the security of the cryptographic key pair is improved over the case where a single seed is used to generate the cryptographic key pair.

The processor may be further configured to:

generate a cryptographic proof that a specific seed of the plurality of seeds is used to define the composite seed; and
provide the proof to the respective user.

It is an advantage of this device that each user receives proof that their seed was used to define the composite seed.

The seeds may be combined by ordering the plurality of seeds alphabetically and concatenating them.

It is an advantage of this device that the seeds can be combined in a computationally efficient manner, thereby increasing the speed of the device.

Each of the plurality of seeds may be encrypted by the respective user using a public key of the device before being received.

It is an advantage of this device that the seeds can be transmitted to the device securely.

The processor may be further configured to encrypt the private key before recording it in the non-persistent memory unit.

It is an advantage of this device that the private key is stored more securely in the non-persistent memory.

The processor may be further configured to:

group each subset of the plurality of seeds to define seed groupings, wherein each subset comprises at least a predetermined number of seeds;
generate a composite seed encryption for each seed grouping by encrypting the composite seed using the seed grouping; and
record each composite seed encryption in a persistent memory unit.

The processor may be further configured to:

receive a subset of the plurality of seeds, the subset having at least the predetermined number of seeds;
generate a seed grouping using the subset of the plurality of seeds; identify a composite seed encryption in the persistent memory unit which corresponds to the defined seed grouping;
decrypt the composite seed encryption using the defined seed grouping;
re-generate the key pair using the composite seed and the deterministic key generation method, the key pair comprising the public key and the private key; and
record the private key in the non-persistent memory unit.

It is an advantage of this device that the key pair can be re-generated using a subset of the seeds. This removes the need for all users to provide a seed in the case that the key pair is to be re-generated.

The composite seed encryption may be identified using an identification tag generated from the seed grouping.

The processor may be further configured to:

generate a plurality of shares of the composite seed using a secret sharing method; and
provide, to at least a threshold number of the plurality of users, a share of the composite seed.

The processor may be further configured to:

receive a threshold number of shares of the composite seed;
determine the composite seed using the threshold number of shares;
re-generate the key pair using the composite seed and the deterministic key generation method, the key pair comprising the public key and the private key; and
record the private key in the non-persistent memory unit.

It is an advantage of this device that the key pair can be re-generated using shares of the composite seed. This removes the need for all users to provide an input in the case that the key pair is to be re-generated.

The share may be generated using a technique selected from Shamir's secret sharing technique, Feldman's secret sharing technique, Pederson's secret sharing technique or Stadler's secret sharing technique.

The device may comprise a trusted platform module for generating and storing the key pair.

According to another aspect, there is provided a method for generating a cryptographic key pair, the method comprising:

receiving a plurality of seeds from a respective plurality of users;
combining the seeds to define a composite seed; and
generating the key pair using the composite seed and a deterministic key generation method, the key pair comprising a public key and a private key.

The method may further comprise:

generating a cryptographic proof that a specific seed of the plurality of seeds is used to define the composite seed; and
providing the proof to the respective user.

The method may further comprise:

grouping each subset of the plurality of seeds to define seed groupings, wherein each subset comprises at least a predetermined number of seeds;
generating a composite seed encryption for each seed grouping by encrypting the composite seed using the seed grouping; and
recording each composite seed encryption in a persistent memory unit.

The method may further comprise:

receiving a subset of the plurality of seeds, the subset having at least the predetermined number of seeds;
generating a seed grouping using the subset of the plurality of seeds;
identifying a composite seed encryption in the persistent memory unit which corresponds to the defined seed grouping;
decrypting the composite seed encryption using the defined seed grouping;
re-generating the key pair using the composite seed and the deterministic key generation method, the key pair comprising the public key and the private key; and
recording the private key in the non-persistent memory unit.

The method may further comprise:

generating a plurality of shares of the composite seed using a secret sharing method; and
providing, to at least a threshold number of the plurality of users, a share of the composite seed.

The method may further comprise:

receiving a threshold number of shares of the composite seed;
determining the composite seed using the threshold number of shares;
re-generating the key pair using the composite seed and the deterministic key generation method, the key pair comprising the public key and the private key; and
recording the private key in the non-persistent memory unit.

According to another aspect, there is provided a non-transitory computer readable medium configured to store software instructions that when executed cause a processor to perform the above method.

### BRIEF DESCRIPTION OF DRAWINGS

FIG. 1 is a schematic diagram of a system for securely generating a cryptographic key pair,

FIG. 2 is a flow chart illustrating a method for generating a cryptographic key pair;

FIG. 3 is a flow chart illustrating a method for generating a cryptographic key pair;

FIG. 4 is a flow chart illustrating a method for generating a cryptographic key pair:

FIG. 5 is a schematic illustration of an exemplary implementation of the method of FIG. 4;

FIG. 6 is a flow chart illustrating a method for re-generating a cryptographic key pair;

FIG. 7 is a flowchart illustrating a method for generating a cryptographic key pair;

FIG. 8 is a flow chart illustrating a method for re-generating a cryptographic key pair;

FIG. 9 is a schematic diagram of an exemplary system for securely generating a cryptographic key pair; and

FIG. 10 is a flow chart illustrating a method for generating a cryptographic key pair.

### DESCRIPTION OF EMBODIMENTS

The risk of loss or theft of private keys is high when users manage their own keys and can have dramatic consequences. These may include total loss of cryptocurrency, loss or theft of data, unauthorised access to systems due to identity theft, or the user being permanently locked-out of the system. This risk may be even higher when the system is accessed from multiple devices, as a user will often have a copy of the private key residing on each device. Further, when a system is used by a group of users to access the same data, every user is often required to have a copy of the private key to be able to access the system/data, which provides more chance for the key to be stolen.

Not only are private keys a potential target for theft, but also the seeds used to generate them. Seeds are pieces of information arbitrarily defined by a user or other system, and are typically easier to remember. Users will often store their seeds as a backup to re-generate their key pairs if lost, and these seed backups are also vulnerable to theft.

The systems and methods described herein offer a cryptography service allowing users to securely generate and use cryptographic key pairs for data encryption, decryption, signing and verification and any other operations requiring the use of cryptographic keys, while reducing the potential for their loss or theft.

### Overview

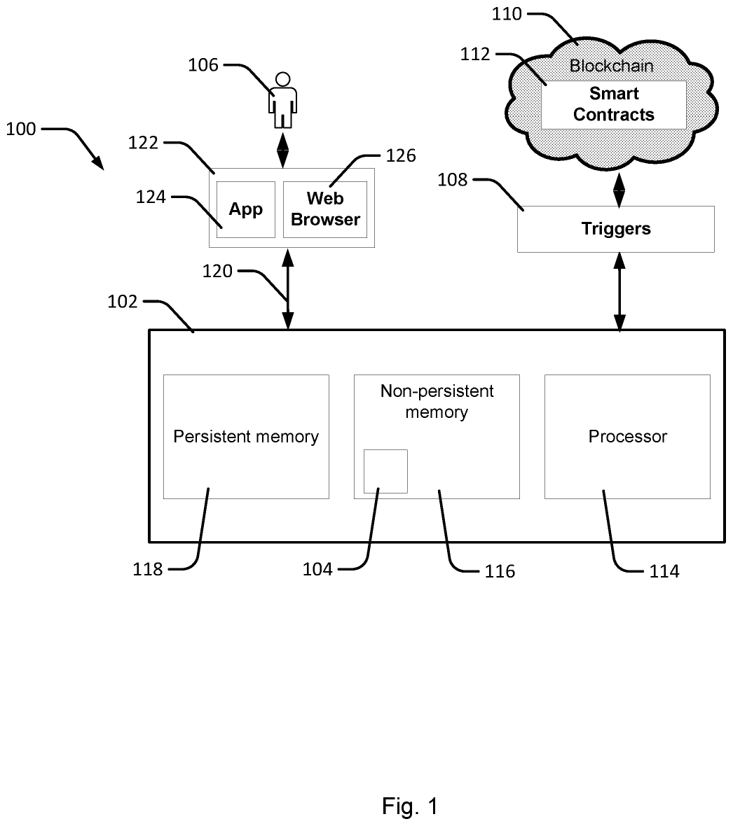

FIG. 1 presents a schematic diagram of a system 100 for secure generation, storage and use of a private key of a cryptographic key pair. System 100 comprises a device 102 for generating and storing a private key 104 of a cryptographic key pair on behalf of an entity 106. In practice, entity 106 comprises a plurality of users, each with an ownership claim or right to use private key 104. For example, entity 106 may be a board of directors or partners in a business.

Device 102 is authorised to apply key 104 to authorize transactions such as payments, signing of digital objects or encryption/decryption of data. The authorisation can be explicitly provided by entity 106 (or an appropriate representative) for individual matters. Authorisation can also be automated using predetermined conditions such that when these conditions are met, as indicated by triggers 108, device 102 applies key 104. For example, a payment can be authorised using key 104 after evidence of some completed work is presented. In some embodiments, these triggers are recorded on a blockchain 110 which can also record smart contracts 112 or other digital objects such as cryptocurrency.

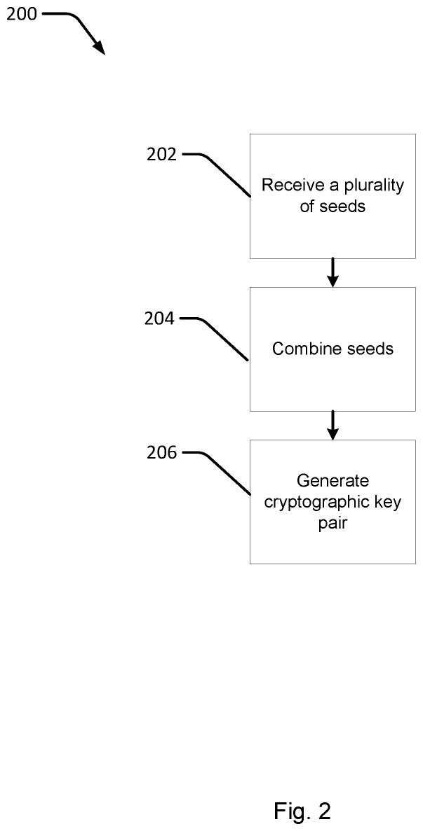

Device 102 comprises a processor 114, a non-persistent memory unit 116 and a persistent memory unit 118. Processor 114 is configured to perform method 200 of FIG. 2 to generate and store private key 104. Initially, at step 202, device 102 receives a plurality of seeds. Each seed is provided by a respective user belonging to entity 106 over a communication network 120. Users are contacted by email, for example, to invite them to provide their seed. The provision of the seeds is also referred to as the seeding process.

Communication network 120 may be any suitable communication channel such as the internet, a package network, a local area network (LAN) a wireless LAN etc. The seeds are pieces of information arbitrarily defined by the user. For example, a seed format may be:
A sequence of alphanumerical characters;
A pin (N digits, N=4,6,8 or more);
A pattern (similar to how patterns can be formed on mobile phones, or other types of patterns).

Regardless of the format used, all seed formats are ultimately converted to a predetermined format. For example, in some embodiments, the seeds are converted to be represented as a sequence of alphanumerical characters. In other embodiments, the seeds are converted to be represented in hexadecimal. In further embodiments, the seeds are converted to be represented in binary format. Conversion of the seeds to the predetermined format can be performed by a client device 122 or by device 102.

In some embodiments, the seeds are encrypted by the user before the user provides them to device 102. This can be achieved using a public key of device 102 before transmitting the seeds to device 102. This method ensures that a malicious agent is unable to decipher the seed if it is intercepted.

The encryption and communication of the seed from the users to device 102 is facilitated by a client terminal 122 hosting an application 124 and a browser 126. Application 124 facilitates in establishing communications between client terminal 122 and device 102 and may include emailing functionality as well as cryptographic capabilities to authenticate the user and encrypt the seed before transmitting it over communication network 120. It will be appreciated that more than one client terminal can be used. For example, each user may have their own terminal 122.

At step 204, the plurality of seeds are combined to define a composite seed. Various methods can be used for combining of the seeds. In some embodiments, a deterministic process is used, while in other embodiments a non-deterministic method is used. An exemplary deterministic method, for use when the predetermined format is alphanumeric characters, is to order each of the seeds in alphabetical order followed by a concatenation of the seeds. This process will be referred to as the stitching approach. For example, consider the following seeds being received by device 102:

### S1=“ABC”

### S2=“XYZ”

### S3=“EFG”

The composite seed is given by S1+S3+S2=“ABC”+“EFG”+“XYZ”=“ABCEFGXYZ”. The stitching approach has the advantage that it is easy to implement and is not computationally demanding. Other deterministic approaches are also possible. For example, to avoid having a long composite seed, seeds could be combined vertically, meaning that the n'th characters of all seeds are combined into the n'th character of the composite seed. Combining multiple characters into one could be based on the mean of their numeric representation (e.g. using ascii codes). This produces a composite seed which length is exactly the length of the longest seed. Considering the same example as above, “A”+“E”+“X”=ASCII((65+69+88)/3)::ASCII(74)=“J”. Applying this method to every n'th character of the seeds results in the composite seed being “JKL”.

Deterministic methods are suitable for embodiments which require that the same composite seed can be obtained from the same set of seeds (through re-seeding), which in turn can re-generate the same key 104. This can also be used for embodiments which only require a subset of seeds to obtain the same composite seed. These processes are discussed in more detail below.

In some embodiments, a non-deterministic method can be used to combine the plurality of seeds to define the composite seed. For example, the seeds can be concatenated in the order they are received. Using the above example, the composite seed would be “ABCXYZEFG”. Another method may be to concatenate the seeds in a random order. Other non-deterministic methods are also possible. Non-deterministic methods are suitable for embodiments which only require a subset of seeds to regenerate key 104. This process is discussed in more detail below.

At step 206, the composite seed from step 204 is used, in conjunction with a deterministic key generation method, to generate a cryptographic key pair comprising a public key and private key 104. Any deterministic, asymmetric key generation algorithm is suitable for the purposes of step 206. For example, in some embodiments, Elliptic Curve keys can be adopted and the Elliptic Curve Integrated Encryption Scheme (ECIES) can be used for encryption/decryption and the Elliptic Curve Digital Signature Algorithm (ECDSA) can be used for signing/verifying data. Other examples include the Rivest-Shamir-Adleman (RSA) algorithm which can be used for both encryption/decryption and signing/verifying data.

Private key 104 is then recorded in non-persistent memory unit 116 and the public key is made available for use. For example, the public key may be recorded on blockchain 110 to allow others to communicate securely with entity 106 via device 102.

Storing private key 104 in non-persistent memory further improves the security of key 104. This is achieved because tampering with non-persistent memory unit 116 is likely to cause loss of power to unit 116 and thereby erasing key 104. Non-persistent memory may be any volatile memory such as cache or Random-Access memory (RAM).

In some embodiments, processor 114 is further configured to encrypt private key 104 before recording it in non-persistent memory unit 116. Encrypting key 104 before recording in unit 116 further enhances security as even if a malicious agent were to successfully read key 104 from unit 116, it would still be encrypted and unusable.

In some embodiments, a trusted platform module is used for executing step 206 and storing key 104.

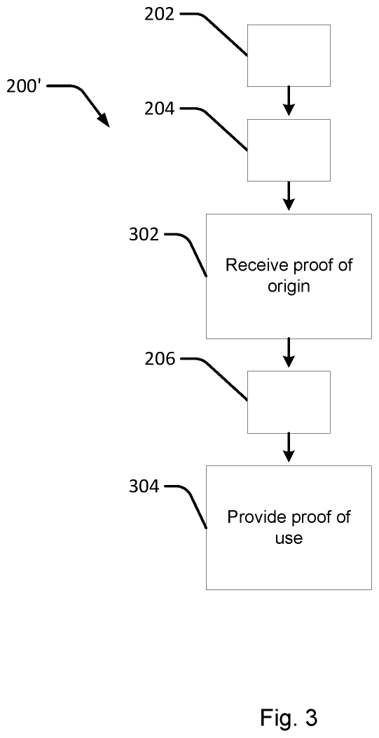

In some embodiments, method 200 is replaced by method 200′, which is illustrated schematically in FIG. 3. Steps of method 200′ which are in common with method 200 have been given identical reference numbers and will not be described again.

At step 302 of method 20′, processor 116 obtains a cryptographic proof that a specific seed, of the plurality of seeds received at step 202, was produced by the corresponding user (proof of origin). Such cryptographic proof could be in the form of the seed itself being signed by the user's own private key. This prevents a malicious agent from being able to intercept a seed and/or replace a seed with their own seed. Processor 116 then executes step 206 to generate the cryptographic key pair. Processor 116 then executes step 304, providing to the user a second cryptographic proof that the seed provided by the user was used in the generation of the composite seed and subsequently in the generation of the cryptographic key pair. Such second cryptographic proof of use could be in the form of the seed itself being signed by the newly created private key.

### Regeneration of Key Pair

As mentioned, after its generation, private key 104 is recorded in non-persistent memory unit 116. In a situation where power is lost to memory unit 116, such as a power failure, hardware replacement or a reboot of device 102, private key 104 stored in unit 116 will be lost. In this case, there will be a requirement to re-generate private key 104. The method for regenerating private key 104 varies according to the specific embodiment as detailed below.

### Using all Seeds

In some embodiments, the re-generation of key 104 is achieved by following the same process that was initially used to generate key 104. That is, each user provides their seed to device 102 as described above. Device 200 then executes either method 200 or method 200′ to re-generate key 104. As discussed above, this embodiment requires the use of a deterministic method for combining the seeds to ensure that the composite seed used for re-generation of key 104 is the same as the composite seed used initially. This ensures that regenerated key 104 is the same as the initial key.

This embodiment requires that each of the users provide their seed for regeneration of key 104. This provides a degree of security but may also be inconvenient in certain circumstances. For example, if there is a requirement for key 104 to be regenerated and one or more of the users is unavailable to provide their seed, then the regeneration of key 104 will be delayed until all users are available to provide their seed.

### Using a Subset of Seeds

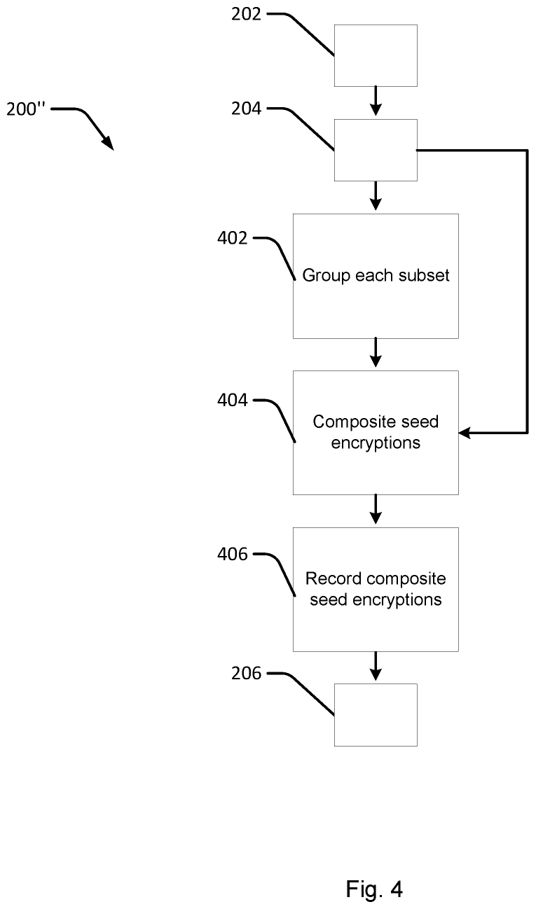

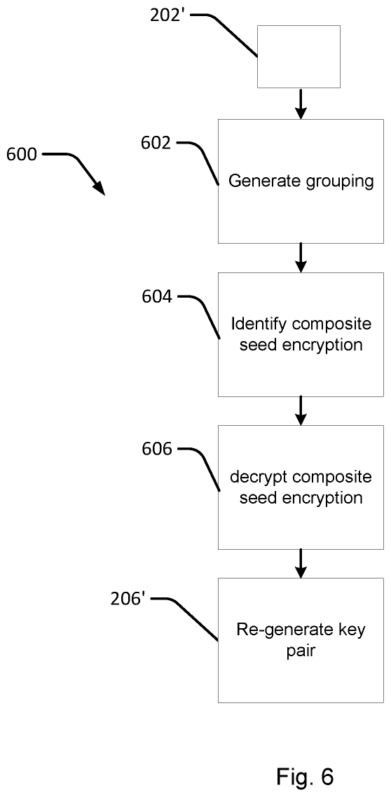

In some embodiments, private key 104 can be regenerated using only a subset of the initial seeds. These embodiments utilise a modified method 200 for the initial generation of key 104. These modified methods are illustrated as methods 200″ of FIG. 4 and method 200′″ of FIG. 6 and will be describe below as Subset Method 1 and Subset Method 2 respectively.

### Subset Method 1

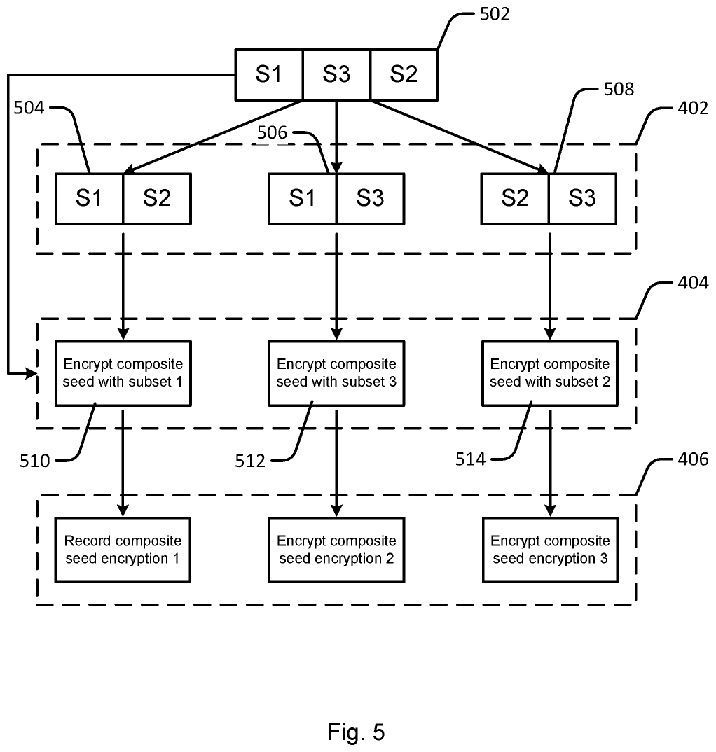

For embodiments employing Subset Method 1, method 200″ of FIG. 4 is used for initial generation of key 104. Method 200″ comprises all of the steps of method 200, which have been given the same reference numerals and will not be described again here. Method 200″ further comprises steps 402 to 406 and will be described by way of example with reference to FIG. 5.

At step 402, the seeds from step 202 are grouped into subsets having a predetermined number of seeds to define seed groupings for each possible combination. In the example shown in FIG. 5, seeds S1, S2 and S3 are received at step 202 and combined to define composite seed 502 at step 204. The seeds are then grouped into subsets of two seeds to define seed groupings 504 to 508. In general, if N seeds are received and the predetermined number of seeds is M (M<=N), then step 402 finds all possible unordered groupings of M seeds. The number of unordered groupings will be at least:

$$( \begin{matrix}N \\ M\end{matrix} ) = \frac{N !}{M ! ( N - M ) !}$$

A composite seed encryption is then generated for each of these groupings at step 404, shown as composite seed encryptions 510 to 514 in FIG. 5. A composite seed encryption is generated by encrypting composite seed 502 from step 204 with one of these groupings 504 to 508, resulting in at least

$$( \begin{matrix}N \\ M\end{matrix} )$$

composite seed encryptions. These composite seed encryptions are then recorded in persistent memory 118 of device 102 at step 406.

In some embodiments, the composite seed encryptions are stored in association with a tag generated from the seed grouping which was used to create the composite seed encryption. These tags can be used to identify which composite seed encryption was generated by a given grouping.

When a re-generation of key 104 is required, device 102 performs method 600 of FIG. 6. At step 202′, device 102 receives a subset of the seeds from a subset of the users. The size of the subset must be at least the predetermined number M. Device 102 then executes step 602, combining the received subset of seeds into a grouping. This grouping will match one of the groupings initially generated at step 402 of method 200″. At step 604, the composite seed encryption generated using this grouping is identified in persistent memory 118 and subsequently decrypted using this grouping at step 606. The decrypted composite seed encryption will be the same as the composite seed used to initially generate key 104, and is used again at step 206′ to re-generate key 104.

In embodiments where an identity tag is not used, method 600 is computationally intensive as the correct composite seed encryption has to be located, potentially through an exhaustive search. However, in certain circumstances this may be beneficial as brute force attacks on the re-seeding process are prevented.

### Subset Method 2

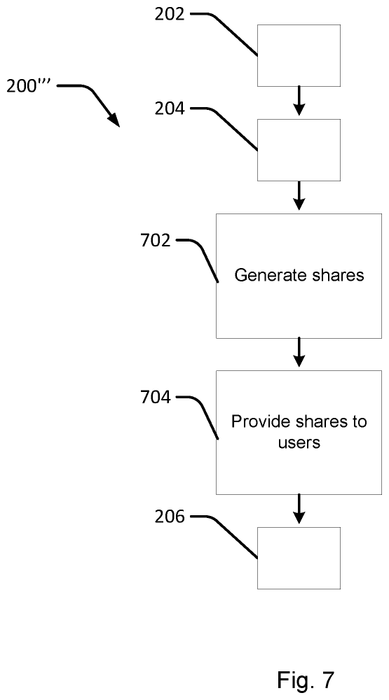

For embodiments employing Subset Method 2, method 200′″ of FIG. 7 is used for initial generation of key 104. Method 200′″ comprises all of the steps of method 200, which have been given the same reference numerals and will not be described again here. Method 200′″ also comprises steps 702 and 704.

At step 702, processor 114 generates shares, also referred to as fragments, of the composite seed using a secret sharing method. At least a threshold number of shares is required. An exemplary method for generating the shares is described below, but other methods are also possible.

In this embodiment, the composite seed is converted to a number, denoted here as a₀. Each share of the composite seed is then generated using the polynomial:

f(x)=a₀+a₁x¹+a₂x²+ . . . +aₖ₋₁x^{k-1}

Where coefficients a₁ to aₖ₋₁ can be assigned randomly. The order of the polynomial determines the threshold number of fragments required to determine the composite seed and is a design parameter of the system. The greater the threshold number, the more shares are required to re-generate private key 104. In this particular example, the threshold number of shares required is k.

A fragment or share is generated by evaluating f(x) for a given value of x. An arbitrary number of fragments can be generated in this fashion. However, it is a requirement that at least the threshold number of fragments are generated from unique x values. That is, f(x) is evaluated for at least k unique values of x. The fragments are then provided to users for storage at step 704. In some embodiments, these shares are encrypted before they are provided to the users.

It will be appreciated that other key secret sharing techniques can be used to generate the key fragments. For example in some embodiments Feldman's secret sharing technique is used, while in other embodiments Pederson's secret sharing technique is used. In yet further embodiments, Stadler's secret sharing technique is used.

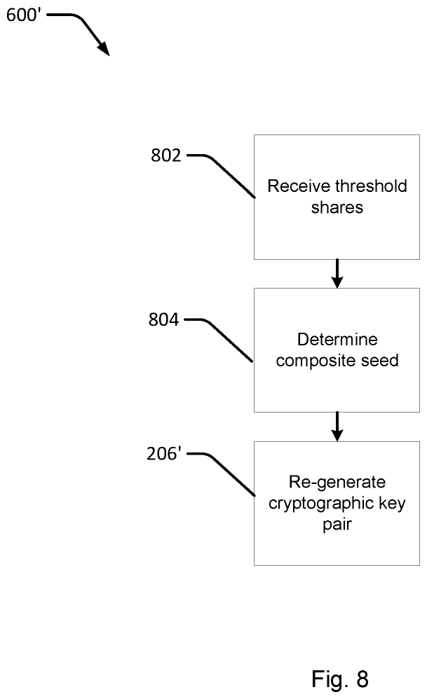

When a re-generation of key 104 is required, device 102 performs method 600′ of FIG. 8. Initially, at step 802, device 102 receives a threshold number of shares from users seeking to regenerate key 104. These users received these shares during the initial generation of key 104 at step 704 of method 200′″ and now provide them back to device 102 when seeking to re-generate key 104. Device 102 then executes step 804, determining the initial composite seed from the shares. This is achieved by interpolating the received shares to recover the polynomial described above. From the polynomial, it is straightforward to determine the initial composite seed a₀ which can then be used to regenerate key 104 at step 206′.

This method has the advantage that the composite seed is not recorded in persistent memory, not even in encrypted form and only requires a threshold number of shares to re-generate key 104. The original seeds become redundant after the shares have been generated.

### EXEMPLARY IMPLEMENTATION

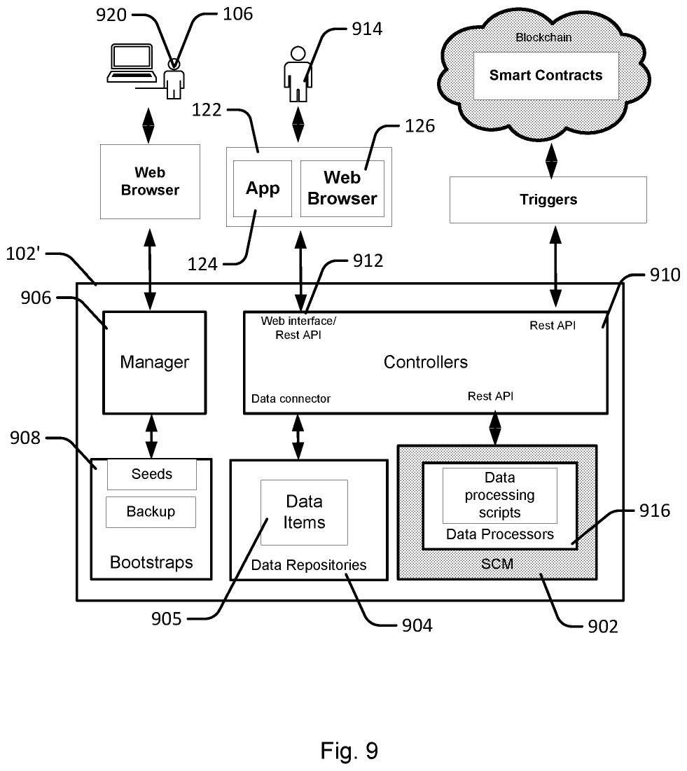

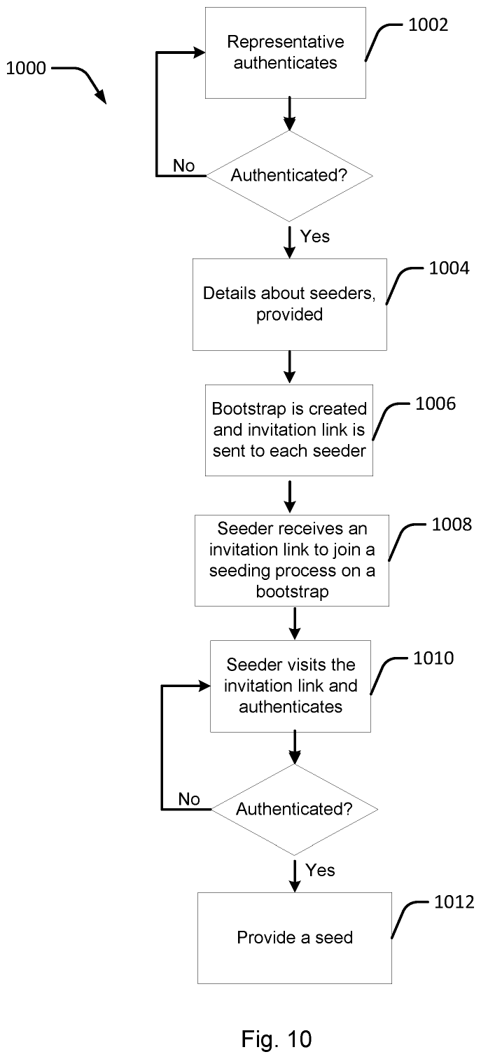

In practice, device 102 is configured to operate using a plurality of modules to carry out the methodology described above. An exemplary configuration of device 102 is illustrated schematically as device 102′ in FIG. 9. The process of initially establishing a key 104 will be described below with reference to this exemplary configuration of device 102 and method 1000 of FIG. 10.

Device 102 comprises a Secure Cryptographic Machine (SCM) 902, a data repository 904, a manager module 906, a bootstrap module 908 and a controller module 910.

Modules 906 to 910 may be software applications stored in memory module 118, which, when executed, perform the methods outlined below. For example, modules 906 to 910 could be functions or classes written in a programming language such as C++ or Java.

In some embodiments modules 906 to 910 are field programmable gate arrays (FPGAs) configured to execute the described methods.

SCM 902 is a hardware device that generates the private key 104 from the composite seed using robust encryption mechanisms and stores it in non-persistent memory. For example, SCM 902 may be an AMD Secure Encrypted Virtualization (SEV) using an AMD Secure Processor as a central processing unit (CPU) of SCM 902. Encryption mechanisms of SCM 902 guarantee that data in non-persistent memory is fully encrypted and is only accessible to the CPU of SCM 902. SCM 902 is further configured so that private keys generated or re-generated are never stored on persistent storage and are not transmitted outside of SCM 902.

Data repositories 904 represents non-persistent memory unit 116 and persistent memory unit 118 and therefore comprises at least one of both persistent and non-persistent storage. Repositories 904 are used to record data items 905 such as files, key-value-stores, documents, software instructions or composite seed encryptions in persistent memory and private keys in non-persistent memory.

Manager module 906 is the only component available when device 102′ is first booted. Manager module 906 comprises a manager web interface which allows signed-in representatives to create, update or delete bootstraps.

Bootstrap module 908 is created by an entity representative 920 through a web interface generated by manager module 906. Bootstrap 908 comprises a list of settings used to create controller module 910, a set of users, a set of data repositories 904 and a set of data processors 916 which are programs that process data and are executed within SCM 902. Before such entities are created, a key generation method, such as method 200, 200, 200″ or 200′″ is required to generate a unique key pair for controller 910.

Controller module 910 connects to data repositories 904 using data connectors and manages the application of private key 104 to various digital objects. For example, controller module 910 manages the encryption/decryption of data, signing etc. by invoking data processors 916 of SCM 902 as well as authenticating users, and providing data services such as storage, processing and data delivery to device 102′. The authentication processes are described in more detail below with reference to FIG. 10.

Controller module 910 includes a web interface and/or Application Programming Interface (API) 912 which facilitates communication between users 914 and device 102′. Users 914 can be users providing seeds for key generation or consumers interested in transacting with entity 106. That is, controller 910 enables a set of APIs and web interfaces to allow users to securely access the encryption, decryption and signing capabilities of device 102′. API 912 is a Representation State Transfer (REST) API.

Data processors 916 execute scripts 918 that run in SCM 902, such as a dedicated Docker instance, in which access is granted to a specific data repository 904 through controller module 910. Data processors 916 have controlled access to the cryptographic functions (encrypt/decrypt/sign/verify) of SCM 902 using the secret key 104. In some embodiments, SCM 902 may run on an AMD Ryzen Pro or AMD Epyc processors, benefiting from their full-memory encryption capabilities. Data processors 916 can be considered as “Add-ons” that can run in that environment and perform added functions. By default, a set of data processors are included in any device 102 (e.g. triggers can run as a data processor allowing to interact with a blockchain network). Users can also run their own code on such secure environment and access the restricted APIs of device 102 to implement, for example, automated use of key 104. For example, SCM 902 can run user-defined code in isolation using Docker container or other virtualisation technologies. Data processor 916 takes data repository 904 as input and produces new data in either aggregated form or analytical results. The new data is stored back on the data repository 904 associated with data processor 916.

FIG. 10 is a schematic illustration of a method 1000 for providing seeds to device 102′. At step 1002, an entity representative authenticates themselves through manager module 906 of device 102′.

In some embodiments, authentication step 1002 is achieved using third party identity providers. For example, these include corporate exchange accounts, google account, social media accounts, etc.

In other embodiments, a blockchain identity can be used to authenticate through a Private Key Challenge (PKC). A PKC starts by requesting the blockchain address of a user. Using the address, manager module 906 retrieves the public key of the user from the blockchain network. A random message is then generated by device 102′ and transmitted to the user, where the user is requested to sign the message with their private key and submit to device 102′ for verification. The signed message is then verified against the user's public key for authentication.

The authenticated representative then provides a list containing information about other users, also referred to as seeders, through the manager module 910 at step 1004. A list of seeders is defined by the representative as a set of identities (e.g. IDs on a blockchain or any other authentication system) along with their contact details (e.g. email addresses). Using this information, at step 1006, a bootstrap 908 is created by the authenticated representative on the manager module 906 web interface.

Each seeder receives an invitation link to join the seeding process on a bootstrap at step 1008. All seeders are contacted (e.g. via email) to invite them to participate in the seeding process.

At step 1010, each seeder is authenticated, for example by following a similar authentication method to the representative. A plurality of seeds are provided at step 1012 from a respective plurality of seeders in the form of a secret message from each seeder to device 102′. Seeders are assured of their seed's inclusion using cryptographic proofs and process around verifying software used by device 102′.

Seeds may be safely communicated to device 102′ using traditional means of encryption. As an illustrative example, when device 102′ boots up, it makes available to the public its unique public key. A Trusted Platform Module (TPM) in SCM 902 may be used to guarantee that the associated private key is safely stored in dedicated hardware physically and permanently linked to device 102′. Any data sent to device 102′ would be required to be encrypted using the device 102′ public key. As such, only device 102′ can decrypt such data.

Once the plurality of seeds have been received, device 102′ carries out one of methods 200, 200′, 200″, 200′″, 600 or 600′ to generate private key 104.

It is expected that there are only two vectors of attack available to a malicious entity trying to obtain key 104. These are to (i) compromise the representative and a sufficient number of seeders simultaneously or (ii) to compromise the hardware encryption mechanisms of device 102.

### Use Cases

Device 102 can be used in a corporate environment or for personal use. In some embodiments, device 102 may be deployed as a cloud sandbox, a physical machine or on a virtual appliance.

In an embodiment, device 102 is deployed as a cloud sandbox as an online service on a secure shared environment, and may be utilised as a starting point for an evaluation trial. Device 102 as a cloud sandbox is not meant to be used in production, since private keys generated in the sandbox are not guaranteed to be persistent nor fully protected against hardware attacks (the hardware being managed by the cloud third party). However, many cloud providers are starting to deploy hardware solutions that could be used by device 102 in the future to enable security measures even in the cloud sandbox flavour. That would allow device 102 to be delivered as a cloud service and match the security level of the physical and virtual appliances.

In another embodiment, device 102 is a physical machine, utilised for small business and personal use. That is, a pre-configured physical machine is provided with hardware security. In a further embodiment, device 102 may also be deployed as a virtual appliance on a private data centre, being ideal for corporate environments. Device 102 as a physical machine or virtual appliance supports hardware based full memory encryption, providing extra security and ensuring private keys are never at risk of theft.

Device 102 as a cloud sandbox would be accessible via a public URL Device 102 as a physical machine would be accessible via its unique IP address, while Device 102 as a virtual appliance would be accessible internally in a corporate environment, depending on network configuration.

In another embodiment, device 102 can be used as a “hot” crypto wallet, in contrast to “cold” crypto wallets. As the device 102 retains the private key and keeps running live at all times, the device 102 could be configured to automatically act on behalf of the user, thus the “hot” nature of an device 102, without the use of smart contracts (e.g. pay monthly subscription fees, send regular donations to charity, sell and buy cryptocurrency based on market fluctuations, etc.).

In another embodiment, device 102 can be used as a “shared” crypto wallet allowing multiple users to safely transact with the same private key, and yet be accountable. Device 102 can monitor who transacts and when, enforce voting processes or “manager authorisation requests” to be issued before a transaction is signed. This would be useful in a corporate environment for a more streamlined and transparent expense management. It can also be useful in a situation where a minimum number of directors are required to authorise an act, with device 102 requiring this minimum number of directors to authorise use of the private key for the act. It could also be used in the banking sector to safely manage concurrent access to the same bank account (partners, relatives, fintech service providers, etc.).

In another embodiment, device 102 can be used as a secure data silo to store data in encrypted form, yet be able to share it with designated participants. The Cloud based device 102 could provide such capability as a more secure alternative to existing cloud based storage services.

In yet another embodiment, device 102 can be used as a secure identity provider. Each user would have a securely generated private key that can be used to authenticate into third party online services. As the device 102 retains the private key of every user and keeps running live at all times, it could monitor all authentication activities and even automatically log out users from services that are not in use.

Device 102 offers restricted APIs within a secure environment hosted inside device 102, without exposing the private keys. Such secure environment hosts data processors 916 as shown in FIG. 9. Data processors can be considered as “Add-ons” that can run in that environment and perform added functions. By default, a set of data processors are included in some embodiments of device 102 (e.g. triggers can run as a data processor allowing to interact with a blockchain network). Users can also run their own code on such secure environment and access the restricted APIs of device 102. For example, SCM 902 can run user-defined code in isolation using Docker container or other virtualisation technologies.

User defined data processors could be traded on a marketplace. For example, a web based document editing service could use a backend running on devices 102 and purchased on the marketplace. Another example could be a data processor capable of quickly reacting to cryptocurrency fluctuations to automatically trade bitcoin. Such data processor could be available to purchase on a marketplace. The marketplace itself could be running on a device 102, and would inherit the safety capabilities of device 102.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A device for generating and storing a cryptographic key pair, the device comprising:
a non-persistent memory unit; and
a processor configured to:
receive a plurality of seeds from a respective plurality of users;
combine the seeds to define a composite seed;
generate the key pair using the composite seed and a deterministic key generation method, the key pair comprising a public key and a private key; and
record the private key in the non-persistent memory unit.

2. The device of claim 1 wherein the processor is further configured to:
generate a cryptographic proof that a specific seed of the plurality of seeds is used to define the composite seed; and
provide the proof to the respective user.

3. The device of claim 1 wherein the seeds are combined by ordering the plurality of seeds alphabetically and concatenating them.

4. The device of claim 1 wherein each of the plurality of seeds is encrypted by the respective user using a public key of the device before being received.

5. The device of claim 1 wherein the processor is further configured to encrypt the private key before recording it in the non-persistent memory unit.

6. The device of claim 1 wherein the processor is further configured to:
group each subset of the plurality of seeds to define seed groupings, wherein each subset comprises at least a predetermined number of seeds;
generate a composite seed encryption for each seed grouping by encrypting the composite seed using the seed grouping; and
record each composite seed encryption in a persistent memory unit.

7. The device of claim 1 wherein the processor is further configured to:
receive a subset of the plurality of seeds, the subset having at least the predetermined number of seeds;
generate a seed grouping using the subset of the plurality of seeds;
identify a composite seed encryption in the persistent memory unit which corresponds to the defined seed grouping;
decrypt the composite seed encryption using the defined seed grouping;
re-generate the key pair using the composite seed and the deterministic key generation method, the key pair comprising the public key and the private key; and
record the private key in the non-persistent memory unit.

8. The device of claim 6 wherein the composite seed encryption is identified using an identification tag generated from the seed grouping.

9. The device of claim 1 wherein the processor is further configured to:
generate a plurality of shares of the composite seed using a secret sharing method; and
provide, to at least a threshold number of the plurality of users, a share of the composite seed.

10. The device of claim 9 wherein the processor is further configured to:
receive a threshold number of shares of the composite seed;
determine the composite seed using the threshold number of shares;
re-generate the key pair using the composite seed and the deterministic key generation method, the key pair comprising the public key and the private key; and
record the private key in the non-persistent memory unit.

11. The device of claim 9 wherein the share is generated using a technique selected from Shamir's secret sharing technique, Feldman's secret sharing technique, Pederson's secret sharing technique or Stadler's secret sharing technique.

12. The device of claim 1 comprising a trusted platform module for generating and storing the key pair.

13. A method for generating a cryptographic key pair, the method comprising:
receiving a plurality of seeds from a respective plurality of users;
combining the seeds to define a composite seed; and
generating the key pair using the composite seed and a deterministic key generation method, the key pair comprising a public key and a private key.

14. The method of claim 13 further comprising:
generating a cryptographic proof that a specific seed of the plurality of seeds is used to define the composite seed; and
providing the proof to the respective user.

15. The method of claim 13 further comprising:
grouping each subset of the plurality of seeds to define seed groupings, wherein each subset comprises at least a predetermined number of seeds;
generating a composite seed encryption for each seed grouping by encrypting the composite seed using the seed grouping; and
recording each composite seed encryption in a persistent memory unit.

16. The method of claim 13 further comprising:
receiving a subset of the plurality of seeds, the subset having at least the predetermined number of seeds;
generating a seed grouping using the subset of the plurality of seeds;
identifying a composite seed encryption in the persistent memory unit which corresponds to the defined seed grouping;
decrypting the composite seed encryption using the defined seed grouping;
re-generating the key pair using the composite seed and the deterministic key generation method, the key pair comprising the public key and the private key; and
recording the private key in the non-persistent memory unit.

17. The method of claim 13 further comprising:
generating a plurality of shares of the composite seed using a secret sharing method; and
providing, to at least a threshold number of the plurality of users, a share of the composite seed.

18. The method of claim 17 further comprising:
receiving a threshold number of shares of the composite seed;
determining the composite seed using the threshold number of shares;
re-generating the key pair using the composite seed and the deterministic key generation method, the key pair comprising the public key and the private key; and
recording the private key in the non-persistent memory unit.

19. A non-transitory computer readable medium configured to store software instructions that when executed cause a processor to perform the method of claim 13.
